(19) United States
(12) Patent Application Publication
(10) Pub. No.: US 2011/0031855 A1
(43) Pub. Date: Feb. 10, 2011

(54) WASHER

(75) Inventors: Nursel Karakaya, Istanbul (TR); Bahar Akar, Istanbul (TR)

Correspondence Address: VENABLE, CAMPILLO, LOGAN & MEANEY, P.C., 1938 E. OSBORN RD, PHOENIX, AZ, 85016-7234, US

(73) Assignee: ARCELIK ANONIM SIRKETI, Instanbul (TR)

(21) Appl. No.: 12/811,365

(22) PCT Filed: Dec. 6, 2008
(86) PCT No.: PCT/EP2008/066964

§ 371 Date: Oct. 30, 2010

(30) Foreign Application Priority Data
Dec. 31, 2007 (TR) A2007/09236

(51) Int. Cl. E06B 7/16; D06F 39/14; A47L 15/42

(52) U.S. Cl. 312/228; 49/475.1

(57) ABSTRACT

The present invention relates to a washer (1) comprising a sealing element (6) that contains antimicrobial material thereby preventing the formation of bacterial plaque and mold on the surface thereof.

The present invention relates to a washer wherein the hygienic conditions in the washing chamber are enhanced.

The washer of the present invention is a dishwasher or a washing machine. In the said washers, a sealing element, for example a gasket or bellows, is used between the door and the washing chamber to provide leak-proofing. The sealing element is generally produced of elastomeric materials such as EPDM rubber. In time, formation of bacterial plaque and mold is observed on the sealing element as a result of repetitious washing processes. The said bacterial plaque or mold creates a problem in terms of the washing process hygiene. The formation of bacterial plaque and mold increases particularly on the folds of the sealing element or in points hard to access by the wash water.

The aim of the present invention is the realization of a washer wherein the formation of bacterial plaque and mold is prevented on the sealing element between the door and the washing chamber.

The washer realized in order to attain the aim of the present invention is explicated in the claims.

In the washer of the present invention, the sealing element, disposed between the door and the washing chamber, contains an antimicrobial additive. The sealing element is produced of TPE and zinc pyrithione compound material. The TPE material is polystyrene/elastomer block copolymer (e.g. SEBS or SBS) or thermoplastic vulcanizate. TPE is a thermoplastic vulcanizate preferably a compound of EPDM and PP.

The sealing element is made by mixing in 95-97% TPE material by weight and 3-5% master batch material by weight. Master batch is a polyolefin carrying material that contains 1-10% zinc pyrithione.

The washer of the present invention can be a dishwasher or a washing machine.

The formation of bacterial plaque and mold on and in the vicinity of the sealing element is prevented by means of the antimicrobial additive substance added into the material of which the sealing element is produced.

The washer realized in order to attain the aim of the present invention is illustrated in the attached figures, where:

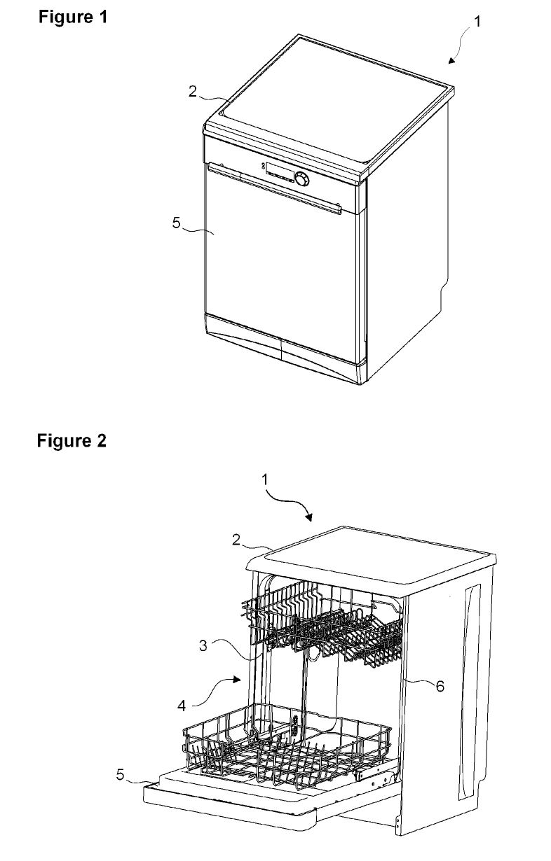

FIG. 1—is the perspective view of a washer in the door closed position.

FIG. 2—is the perspective view of a washer in the door open position.

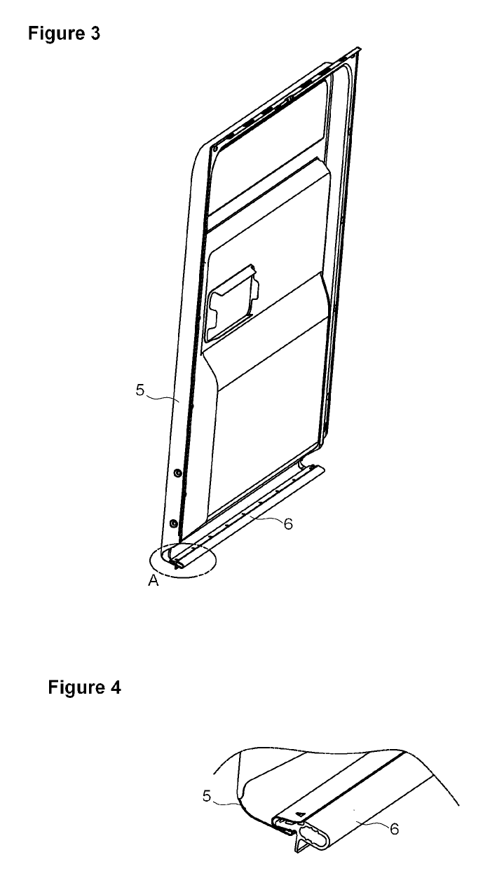

FIG. 3—is the detailed perspective view of a washer door and the sealing element thereon.

FIG. 4—is the view of detail A in FIG. 3.

The elements illustrated in the figures are numbered as follows:

1. Washer

2. Body

3. Washing chamber

4. Loading port

5. Door

6. Sealing element

The washer (1) comprises a body (2), a washing chamber (3) wherein the washing process is performed, a loading port (4) for loading the items to be washed into the washing chamber (3), a door (5) that covers the loading port (4) and a sealing element (6) disposed between the loading port (4) and the door (5) (FIG. 1, FIG. 2, FIG. 3 and FIG. 4).

The formation of bacterial plaque and mold on the sealing element (6) is prevented by adding an antimicrobial additive substance into the material used for producing the sealing element (6). The sealing element (6) is produced of thermoplastic elastomer (TPE) material. Zinc pyrithione (ZnPT, C₁₀H₈N₂O₂S₂Zn) is used as the antimicrobial substance.

The sealing element (6) is subjected to high temperatures (40° C.-90° C.) during the washing process and is in continuous contact with the wash water containing cleaning agents dissolved therein in an environment with a high level of humidity. The temperature, humidity, the cleaning agents and the mechanical effect of the water increases the migration of the zinc in the sealing element (6) to air and the wash water. The rate of zinc pyrithione in the sealing element (6) is determined by taking into consideration the environmental conditions in the sealing element (6) region during the washing process so that the sealing element (6) can sustain the desired antimicrobial effect during the useful life of the washer (1). Another factor considered in determining the rate of zinc pyrithione is the amount of zinc mixed into the wash water. Some portion of the zinc mixed into the wash water remains on the washed item and the remainder is discharged together with the wash water. Accordingly, the amount of zinc has to be at a level not hazardous to human health and the environment.

TPE provides advantages in recyclability and ease of production. TPE material is polystyrene/elastomer block copolymer (e.g. SEBS or SBS) or thermoplastic vulcanizate (EPDM/PP). TPE material used in the sealing element (6) is a thermoplastic vulcanizate (TPV) preferably obtained from a compound of EPDM and polypropylene (PP) and is in granule form.

In the sealing element (6) a master batch material carrying polyolefin, containing 1-10% zinc pyrithione is used as the antimicrobial additive substance.

The sealing element (6) is produced by mixing TPE material and the antimicrobial additive substance in a master batch form, melting by heating and forming by extrusion or injection methods.

For determining the amount of antimicrobial additive substance to be included in the sealing element (6), samples are produced by using 3% and 5% antimicrobial material respectively and the samples are subjected to various tests for assessing the rate of zinc pyrithione that will provide the continuity of antimicrobial effect in the sealing element (6) and the migration of zinc at a safe level health-wise.

### Tests

The method of the present invention is applied on various samples and these samples are subjected to some tests in order to measure the antimicrobial effects and endurances. The bacterial plaque adherence test (JIS Z 2801: 2000E Film Adherence Method—AATC Test Method 100) is a frequently used method since it determines the effect on bacteria cells quantitatively in an environment not containing nutrients. During the test, a solution containing 10⁵-10⁶ cfu bacteria is engrafted on samples of 50 mm×50 mm. A waiting period of 24 hours is applied at a temperature of 23-35° C. depending on the type of bacteria used (Coliform bacillus—E.c., staphylococcus—S.a., etc.). The number of bacteria still alive (cfu=colony forming unit) is counted by plate counting method. The logarithmic decrease in the number of bacteria as compared with the reference plate is described as the antibacterial effectiveness percentage. Log 2 decrease corresponds to 99% sufficient effectiveness, log 3 decrease to 99.9% and log 4 decrease to 99.99%.

The antimicrobial material field of influence test (Agar Diffusion Methods (Kirby-Bauer)—AATC Test Method 147), is also called Zone of Inhibition method. It is a qualitative evaluation method. The samples are placed on the agar solution (3 mm), the nutrient medium, together with the target microorganisms and incubated at 20-30° C. for 24 hours. The clean halo area formed around the sample shows antimicrobial effectiveness. The test does not yield results if the antimicrobial material migration is too slow. The applicability of the test depends on the diffusion rate of the antimicrobial material made of polymer, solubility and the rate of diffusion in agar.

In operation tests, the washer (1) is loaded with items to be washed having standard dirtiness levels and the standard washing program of the washer (1) is activated. 35° C. and 70° C. are used as the washing temperatures. This process is repeated for 1000 cycles. The antimicrobial effectiveness of the sealing element (6) is measured by the JIS Z 2801: 2000E method before the first cycle and after the 250^{th}, 600^{th} and 900^{th} cycles. For each condition, tests are carried in three washers (1) and the average of the results is given in the following tables:

The samples and test results are given below:

### Sample 1:

In this sample, the sealing element (6) includes antimicrobial additive substance in master batch form 3% by weight, TPE material 97% by weight. Test results are given in Table A.

### Table A:

TABLE 1

| Washing | No. of | | | |
|---|---|---|---|---|
| Temperature | Cycles | Test | Result | Comment |
| — | 0 | JIS Z 2801: | Log 3.84 | Effectiveness |
| | | 2000E | | sufficient |
| — | 0 | Agar Diffusion | 16.4 cm² | Effectiveness |
| | | Methods | | present |
| 35 | 250 | JIS Z 2801: | Log 2.60 | Effectiveness |
| | | 2000E | | sufficient |
| 35 | 600 | JIS Z 2801: | Log 2.70 | Effectiveness |
| | | 2000E | | sufficient |
| 35 | 900 | JIS Z 2801: | Log 3.66 | Effectiveness |
| | | 2000E | | sufficient |
| 70 | 250 | JIS Z 2801: | Log 2.35 | Effectiveness |
| | | 2000E | | sufficient |
| 70 | 600 | JIS Z 2801: | Log 3.72 | Effectiveness |
| | | 2000E | | sufficient |
| 70 | 900 | JIS Z 2801: | Log 3.50 | Effectiveness |
| | | 2000E | | sufficient |

The tests carried out show that this sample is successful in preventing the reproduction of bacteria and molds.

### Sample 2:

In this sample, the sealing element (6) includes antimicrobial additive substance in master batch form 5% by weight, TPE material 95% by weight. Test results are given in Table B.

### Table B:

TABLE 2

| Washing | No. of | | | |
|---|---|---|---|---|
| Temperature | Cycles | Test | Result | Comment |
| — | 0 | JIS Z 2801: | Log 3.75 | Effectiveness |
| | | 2000E | | sufficient |
| — | 0 | Agar Diffusion | 19.7 cm² | Effectiveness |
| | | Methods | | present |
| 70 | 250 | JIS Z 2801: | Log 4.18 | Effectiveness |
| | | 2000E | | sufficient |
| 70 | 600 | JIS Z 2801: | Log 3.67 | Effectiveness |
| | | 2000E | | sufficient |

The tests carried out show that this sample is successful in preventing the reproduction of bacteria and molds. The sealing element (6) contains 95-97% TPE material by weight and antimicrobial additive substance in master batch form 3-5% by weight. The sealing element (6) contains zinc pyrithione of 0.03-0.50% by weight since the antimicrobial material in master batch form contains zinc pyrithione of 1-10% by weight.

In the washer (1) of the present invention, during the washing process, the antimicrobial substance in the sealing element (6) migrates towards the surface of the sealing element (6) and neutralizes the bacteria and the molds on the surface of the sealing element (6). The antimicrobial substance depolarizes the electro-potential of the cell membrane and prevents bacterial/fungal conveyance on the surface of the sealing element (6). Consequently, the formation of bacterial plaque and mold on the surface of the sealing element (6) is prevented.

The zinc pyrithione (ZnPT)-TPE mixture provides considerable advantages over the widely used mixture of EPDM—silver mixture. EPDM used in the sealing elements (6) is a thermoset material which is produced by vulcanizing with sulfur. The desired antimicrobial effect on the sealing element (6) cannot be maintained by the use of silver based materials since sulfur interacts with silver based antimicrobial additive substance. Therefore, in order to use silver based antimicrobial materials as additives, vulcanization has to be done with peroxide. However, vulcanization with peroxide results in the problem of bad odor. Vulcanization with peroxide is avoided since this odor is not desired to emanate in the dishwasher or the washing machine by the consumers.

In an embodiment of the present invention, the washer (1) is a dishwasher and the sealing element (6) is the gasket between the loading port (4) and the door (5).

In another embodiment of the present invention, the washer (1) is a washing machine and the sealing element (6) is the bellows between the loading port (4) and the door (5).

A hygienically enhanced washing medium is provided by the sealing element (6) of the present invention containing an antimicrobial material additive.

1. A washer (1) that comprises a body (2), a washing chamber (3) wherein the washing process is performed, a loading port (4) for loading the items to be washed into the washing chamber (3), a door (5) that covers the loading port (4) and a sealing element (6) disposed between the loading port (4) and the door (5) and characterized by a sealing element (6) produced of thermoplastic elastomer (TPE) material wherein antimicrobial material is added.

2. A washer (1) as in claim 1, characterized by the sealing element (6) that comprises zinc pyrithione (ZnPT) as the antimicrobial substance.

3. A washer (1) as in claim 1 or 2, characterized by the sealing element (6) that is produced of thermoplastic elastomer (TPE) material which is polystyrene/elastomer block copolymer.

4. A washer (1) as in claim 1 or 2, characterized by the sealing element (6) that is produced of thermoplastic elastomer (TPE) material which is a thermoplastic vulcanizate (TPV) derived from EPDM and polypropylene (PP).

5. A washer (1) as in any one of the claims 1 to 4, characterized by the sealing element (6) that is produced by using 95-97% TPE material by weight and 3-5% by weight antimicrobial additive substance in master batch form.

6. A washer (1) as in claim 5, characterized by the sealing element (6) that is produced from an antimicrobial material containing 1-10% zinc pyrithione by weight and polyolefin as the carrier.

7. A washer (1) as in any one of the above claims, characterized by the sealing element (6) that contains 0.03% -0.50% zinc pyrithione by weight.

8. A washer (1) as in any one of the above claims, which is a dishwasher.

9. A washer (1) as in any one of the claims 1 to 7, which is a washing machine.
